(19) United States
(12) Patent Application Publication
(10) Pub. No.: US 2017/0339676 A1
(43) Pub. Date: Nov. 23, 2017

(54) Dynamic Frame Structure for an Enhanced Cellular Network

(71) Applicant: Apple Inc., Cupertino, CA (US)

(72) Inventors: Farouk Belghoul, Campbell, CA (US); Tarik Tabet, Los Gatos, CA (US); Lydi Smaini, San Jose, CA (US)

(21) Appl. No.: 15/485,514

(22) Filed: Apr. 12, 2017

Related U.S. Application Data
(60) Provisional application No. 62/339,486, filed on May 20, 2016.

(51) Int. Cl. H04W 72/04; H04L 5/00; H04L 1/18

(52) U.S. Cl. CPC H04W 72/042; H04W 72/0446; H04L 1/1861; H04L 5/0048

(57) ABSTRACT

A base station is disclosed that may communicate with a wireless device such as a user equipment (UE) using a dynamic frame structure. The base station may transmit control information on a control channel that dynamically specifies a first transmit time interval between control channel transmissions. The duration of the first transmit time interval may be determined based at least in part on a type of service executing on the UE, wherein the type of service may comprise one of machine type communications (MTC), enhanced mobile broadband (eMBB), and critical machine applications.

### PRIORITY CLAIM

This application claims benefit of priority to Application No. 62/339,486 titled “Dynamic Frame Structure for an Enhanced Cellular Network”, filed on May 20, 2016, which is hereby incorporated by reference as though fully and completely set forth herein.

### FIELD

The present application relates to wireless devices, and more particularly to a dynamic frame structure for transmission of data in an enhanced cellular network, such as a 5G network.

### DESCRIPTION OF THE RELATED ART

Wireless communication systems are rapidly growing in usage. In particular, cellular networks are being used by a number of different devices and a number of different services. Newer cellular networks currently under development may be asked to support various advanced services, such as enhanced mobile broadband (eMBB), massive machine type communications (MTC), and critical machine applications such as autonomous cars and similar use cases. Improvements in the field would be desirable.

### SUMMARY

Embodiments are presented herein of methods for configuring and performing cellular communication using a dynamic frame structure, and of devices configured to implement the methods.

According to the techniques described herein, a wireless device such as a user equipment (UE) may communicate with a base station according to a radio access technology. The base station and the UE may communicate control and data information using the dynamic frame structure. In particular, the base station may specify different transmit time interval durations for the UE at different times, based at least in part on the type of application currently being run (or soon to be run) on the UE. Thus, the transmit time interval for the UE may be dynamically configured by the base station via the control channel, depending on the type of UE application.

In some embodiments, a duration of the transmit time interval may be determined based at least in part on a type of service executing on the UE, wherein the type of service may comprise one of machine type communications (MTC), enhanced mobile broadband (eMBB), and critical machine applications.

In some embodiments, the location of the control channel instance (or occasion) for the UE may also be dynamically configured by the base station. For example, the base station may incorporate information in a current instance of the control channel specifying a time and/or location of a next or subsequent instance of the control channel that will contain control information for the UE.

Further, in some embodiments the data transmitted between the base station and the UE is not spread over non-contiguous resource elements in the data channel, but rather contiguous control and data resource elements are used.

In some embodiments, the downlink and uplink ACK/NACKs (HARQ feedback) may be sent over a separate, specific narrowband carrier. Further, the relationship between the data and the ACK/NACK may not be static, but rather may be dynamic, e.g., the relationship between the data and the ACK/NACK may be determined for a particular UE at least partially based on the application(s) currently being executed by the UE. In addition, in the frame structure the pilot signal may not be multiplexed with the data channel as in the current LTE standard, but are sent in the beginning of the TTI, or the beginning of the 10 ms frame.

The techniques described herein may be implemented in and/or used with a number of different types of devices, including but not limited to cellular phones, tablet computers, wearable computing devices, portable media players, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings, in which:

FIG. 1 illustrates an exemplary (and simplified) wireless communication system;

FIG. 2 illustrates a base station (BS) in communication with a user equipment (UE) device;

FIG. 3 illustrates an example wireless cellular communication network, according to some embodiments;

FIG. 4 illustrates an exemplary block diagram of a UE;

FIG. 5 illustrates an exemplary block diagram of a BS;

FIGS. 6 and 7 illustrate a dynamic TDD frame structure for cellular communication which uses a separate HARQ ACK/NACK channel according to some embodiments;

FIG. 8 illustrates an alternative dynamic TDD frame structure for cellular communication according to some embodiments;

FIG. 9 illustrates a dynamic FDD frame structure for cellular communication according to some embodiments; and

FIG. 10 illustrates a LAA frame structure according to some embodiments;

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

The following acronyms may be used in the present disclosure.

3GPP: Third Generation Partnership Project

3GPP2: Third Generation Partnership Project 2

BLER: Block Error Rate (same as Packet Error Rate)

BER: Bit Error Rate

CC: Component Carrier

CE: Control Element

DL: Downlink

eMBB: enhanced Mobile Broadband

GBR: Guaranteed Bit Rate

GSM: Global System for Mobile Communications

LTE: Long Term Evolution

MAC: Media Access Control

MME: Mobility Management Entity

MTC: Machine Type Communications

PER: Packet Error Rate

RACH: Random Access Channel

RAT: Radio Access Technology

Rx: Receive

RSRP: Reference Signal Received Power

RSRQ: Reference Signal Received Quality

RRC: Radio Resource Control

Tx: Transmission

TTI: Transmit Time Interval

UE: User Equipment

UMTS: Universal Mobile Telecommunication System

VoLTE: Voice Over LTE

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

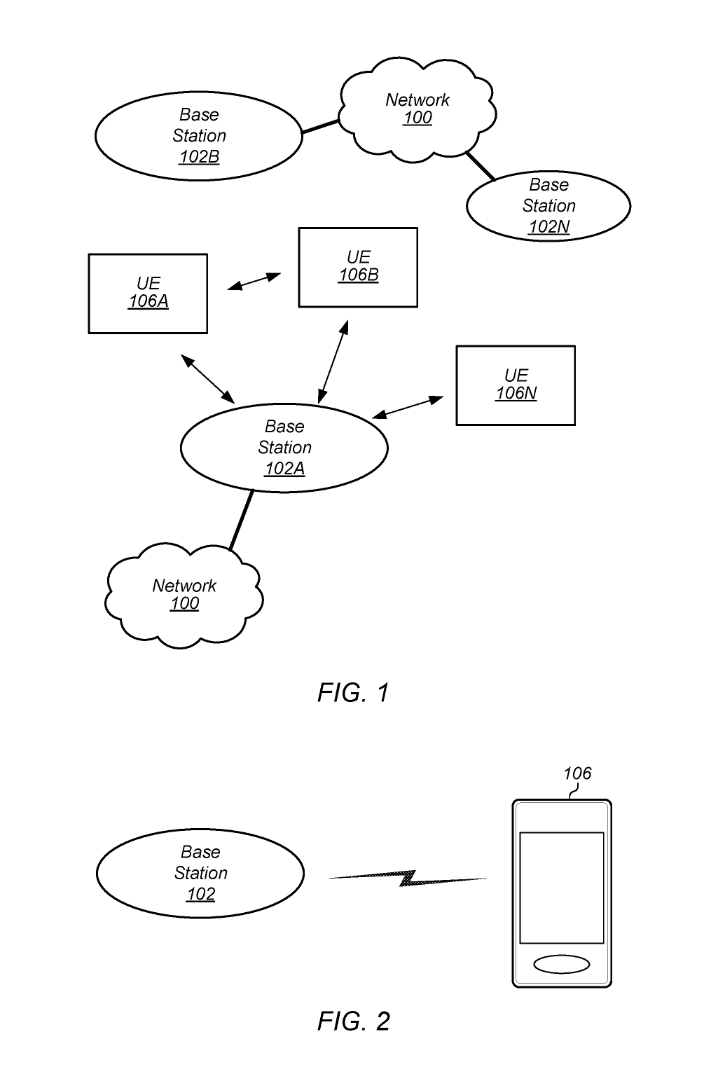

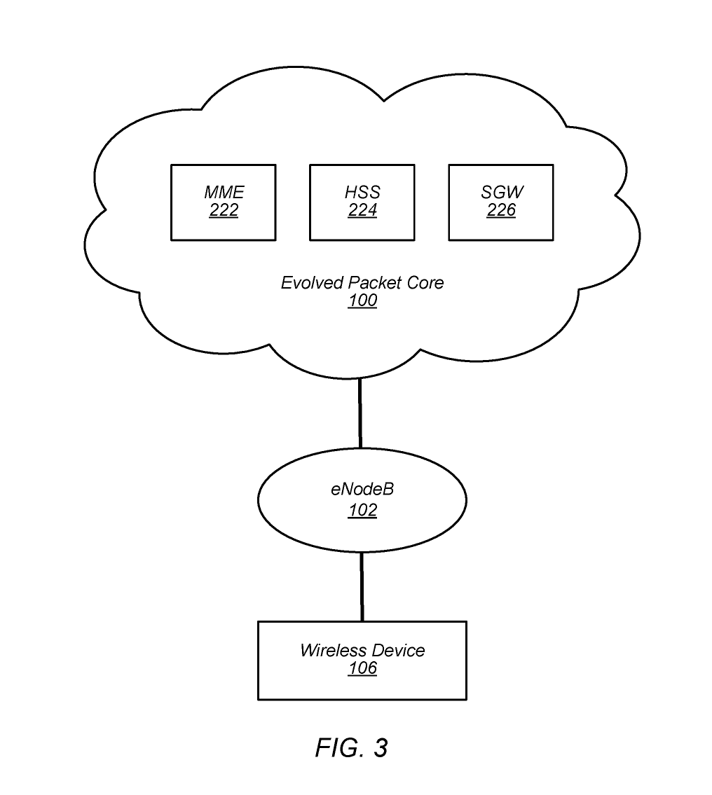

### FIGS. 1 and 2—Communication System

FIG. 1 illustrates an exemplary (and simplified) wireless communication system. It is noted that the system of FIG. 1 is merely one example of a possible system, and embodiments of the invention may be implemented in any of various systems, as desired.

As shown, the exemplary wireless communication system includes a base station 102A which communicates over a transmission medium with one or more user devices 106A, 102B, etc., through 106N. Each of the user devices may be referred to herein as a “user equipment” (UE). Thus, the user devices 106 are referred to as UEs or UE devices.

The base station 102A may be a base transceiver station (BTS) or cell site, and may include hardware that enables wireless communication with the UEs 106A through 106N. The base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (WCDMA, TD-SCDMA), LTE, LTE-Advanced (LTE-A), 3GPP2 CDMA2000 (e.g., 1× RTT, 1×EV-DO, HRPD, eHRPD), Wi-Fi, WiMAX etc.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a wide geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In addition to “infrastructure mode” communication in which UEs 106 communicate with each other and other networks/devices indirectly by way of base stations 102, some UEs may also be capable of communicating in a “peer-to-peer” (P2P) or “device-to-device” (D2D) mode of communication. In such a mode, UEs 106 such as UE 106A and UE 106B may communicate directly with each other (e.g., instead of by way of an intermediate device such as base station 102A). For example, LTE D2D, Bluetooth (“BT”, including BT low energy (“BLE”), Alternate MAC/PHY (“AMP”), and/or other BT versions or features), Wi-Fi ad-hoc/peer-to-peer, and/or any other peer-to-peer wireless communication protocol may be used to facilitate direct communications between two UEs 106.

Note that a UE 106 may be capable of communicating using any of multiple radio access technologies (RATs) or wireless communication protocols, and may be able to communicate according to multiple wireless communication standards. For example, a UE 106 might be configured to communicate using two or more of GSM, UMTS, CDMA2000, WiMAX, LTE, LTE-A, WLAN, Bluetooth, one or more global navigational satellite systems (GNSS, e.g., GPS or GLONASS), one and/or more mobile television broadcasting standards (e.g., AT SC-M/H or DVB-H), etc. Other combinations of wireless communication standards (including more than two wireless communication standards) are also possible.

FIG. 2 illustrates user equipment 106 (e.g., one of the devices 106A through 106N) in communication with a base station 102 (e.g., one of the base stations 102A through 102N). The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), and/or an ASIC, that is configured to perform any of the method embodiments described herein, or any portion of any of the method embodiments described herein.

The UE 106 may include one or more antennas for communicating using one or more wireless communication protocols. In some embodiments, the UE 106 may share one or more parts of a receive and/or transmit chain between multiple wireless communication standards. The shared radio may include a single antenna, or may include multiple antennas (e.g., for MIMO) for performing wireless communications. Alternatively, the UE 106 may include separate transmit and/or receive chains (e.g., including separate antennas and other radio components) for each wireless communication protocol with which it is configured to communicate. As a further alternative, the UE 106 may include one or more radios which are shared between multiple wireless communication protocols, and one or more radios which are used exclusively by a single wireless communication protocol. Other configurations are also possible.

In a similar manner, the base station 102 may include a processor that is configured to execute program instructions stored in memory. The base station 102 may perform any of the method embodiments described herein by executing such stored instructions. Alternatively, or in addition, the base station 102 may include a programmable hardware element such as an FPGA (field-programmable gate array) that is configured to perform any of the method embodiments described herein, or any portion of any of the method embodiments described herein.

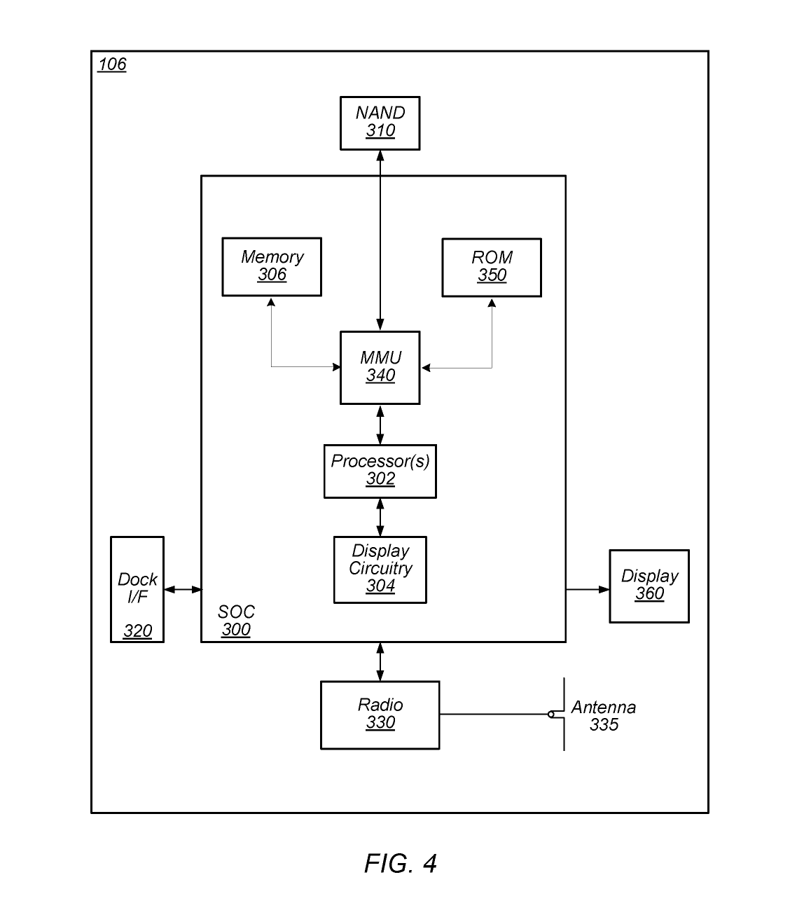

### FIG. 3—Cellular Network

FIG. 3 illustrates an exemplary, simplified portion of a wireless communication system in a cellular network. The cellular network may be a present or future version of LTE. Note that references to LTE herein may include present and/or future versions of LTE, for example including LTE-A. The cellular network may also be a 5G network that may or may not be related to LTE.

As shown, the wireless device 106 may be in communication with a base station, shown in this exemplary embodiment as an eNodeB 102. For example, the wireless device 106 may utilize an evolved UMTS terrestrial radio access (E-UTRA) air interface to communicate with the eNodeB 102.

In turn, the eNodeB may be coupled to a core network, shown in this exemplary embodiment as an evolved packet core (EPC) 100. As shown, the EPC 100 may include mobility management entity (MME) 222, home subscriber server (HSS) 224, and serving gateway (SGW) 226. The EPC 100 may include various other devices and/or entities known to those skilled in the art as well.

The term “network” as used herein may refer to one or more of the base station 102, the MME 222, the HSS 224, the SGW 226 or other cellular network devices not shown. An operation described as being performed by “the network” may performed by one or more of the base station 102, the MME 222, the HSS 224, the SGW 226 or other cellular network devices not shown.

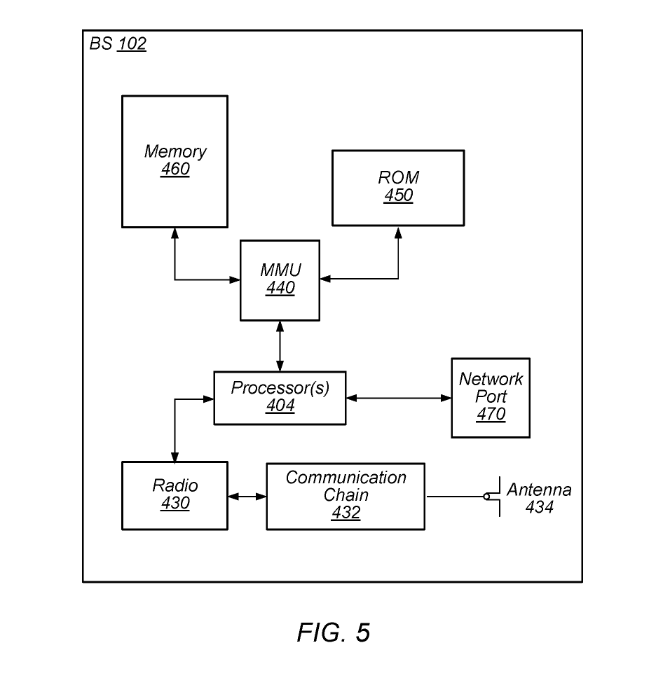

### FIG. 4—Exemplary Block Diagram of a UE

FIG. 4 illustrates an exemplary block diagram of a UE 106. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, Flash memory 310) and/or to other circuits or devices, such as the display circuitry 304, wireless communication circuitry or radio 330, connector OF 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including Flash 310), a connector interface 320 (e.g., for coupling to a computer system, dock, charging station, etc.), the display 360, and wireless communication circuitry (e.g., radio) 330 (e.g., for LTE, Wi-Fi, GPS, etc.).

The UE device 106 may include at least one antenna 335, and in some embodiments multiple antennas, for performing wireless communication with base stations and/or other devices. For example, the UE device 106 may use antenna 335 to perform the wireless communication. As noted above, the UE may be configured to communicate wirelessly using multiple wireless communication standards in some embodiments.

As described further subsequently herein, the UE 106 and/or the base station 102 may include hardware and software components for implementing features or methods described herein in conjunction with cellular communication. For example, the base station 102 and the UE 106 may operate to communicate frames having a dynamic frame structure as described herein.

The processor 302 of the UE device 106 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit). Alternatively (or in addition), the processor 302 of the UE device 106, in conjunction with one or more of the other components 300, 304, 306, 310, 320, 330, 335, 340, 350, 360 may be configured to implement part or all of the features described herein.

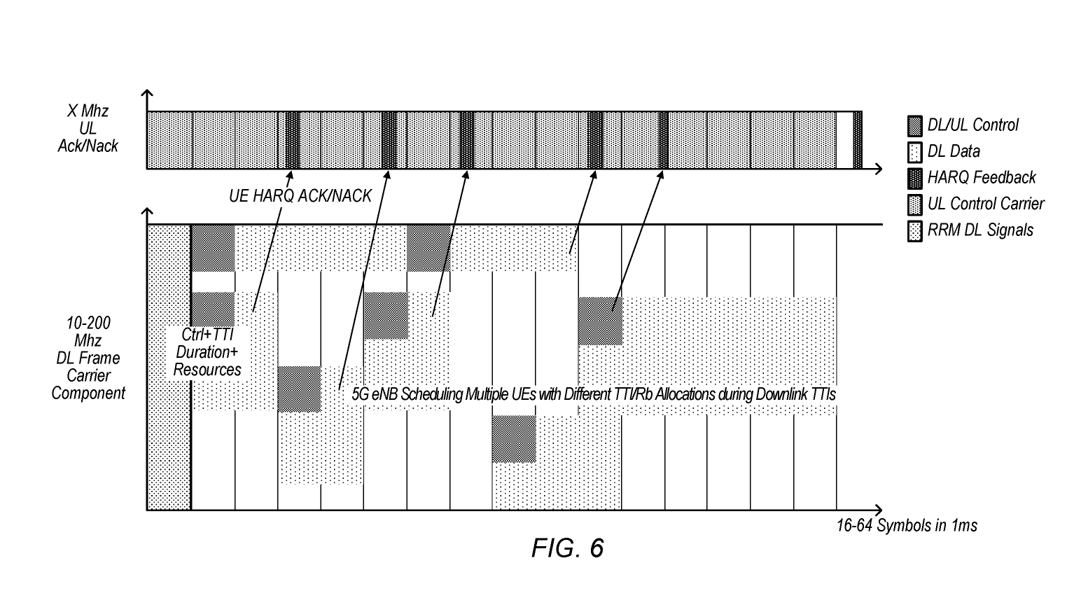

FIG. 5—Exemplary Block Diagram of a Base Station

FIG. 5 illustrates an exemplary block diagram of a base station 102. It is noted that the base station of FIG. 5 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless telecommunication standards, including, but not limited to, LTE, LTE-A, UMTS, CDMA2000, etc.

As described further, the BS 102, as well as various of the network devices in FIG. 3 or otherwise not shown, may include hardware and software components for implementing features such as those described herein. The processor 404 of the base station 102 may be configured to implement part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition), the processor 404 of the BS 102, in conjunction with one or more of the other components 430, 432, 434, 440, 450, 460, 470 may be configured to implement part or all of the features described herein.

### Enhanced Cellular Standards (5G)

Current cellular networks are based on the Long Term Evolution (LTE) network, which was an advance over prior 3G technologies. However, the LTE network has some areas that can be improved. For example, current cellular networks face a shortage of spectrum, being limited to 100 MHz. Newer radio access technologies (RATs), such as the 5G network standard currently in development, will preferably be flexible and scalable to support a greater number of frequency bands, from 400 MHz to 100 GHz.

Newer RATs should also offer improved service flexibility. 4G networks introduced and supported only mobile broadband (MBB), whereas newer 5G networks should be sufficiently flexible to support more advanced services, such as enhanced mobile broadband (eMBB), massive machine type communications (MTC), which may have both low power and very high density requirements, and critical machine applications such as autonomous cars and similar use cases which require high reliability and may operate more efficiently with very short transmission time intervals (TTIs). As one example, eMBB may require additional flexibility in the radio access technology, e.g., it may be desirable for the RAT to be application aware and be able to support a cloud based radio access network (RAN). To support eMBB, it may also be desirable to increase the capacity of current cellular networks through massive deployment of small cells, high frequency reuse, and splitting of the Control and User (C/U) planes of the radio link. New RATs should also be sufficiently flexible for future enhancements and support both licensed and unlicensed spectrum.

Cellular networks are currently used to support voice and data communications as well as various specific applications, such as sensor network monitoring, cloud capabilities, video streaming, automotive communications, real time gaming, remote control of devices, videoconferencing, and disaster alerts, among others. However, newer cellular RATs should be sufficiently flexible to support future applications, such as autonomous driving, augmented reality, virtual reality, and tactile Internet, among numerous others.

### Frame Structure Requirements in Future Cellular Networks

In some embodiments, different services such as MTC, eMBB, critical time applications, etc., utilize different transmit time interval (TTI) durations. MTC applications can have a longer TTI because of the nature of their power consumption. In contrast, eMBB and critical time applications may operate more efficiently with a shorter TTI.

The transmit time interval (TTI) is a parameter in cellular networks that refers to the duration of a transmission on the radio link. In networks with link adaptation techniques based on estimated transmission errors, it may be desirable to have shorter TTIs to enable the base station and the LE to more quickly adapt to changing conditions in the radio link. However, longer TTIs also have several advantages, such as reduced control information overhead as well as increased efficiency of error-correction and compression techniques. These two contradicting requirements have historically determined the choice of the TTI duration.

### Dynamic Frame Structure

In some embodiments described herein, cellular transmissions are constrained in time and space to allow for coexistence with other technologies. In contrast, the current LTE standard, the resource elements could be spread over 20 MHz and over a 1 ms TTI. This results in reduced efficiency when the spectrum is shared with multiple services or uses license assisted access (LAA) services.

In addition, in some embodiments the radio resources allocated for control may be dynamic (non-static) to “fit” the preferred dynamic TTI size of these different applications. In static TDD, the network may define a 10 ms frame format where the transmission sequence may be downlink, downlink, followed by uplink, uplink. In dynamic TDD as described herein, the TDD frame format can be changed over time for a particular UE, e.g., at least in part dependent on the current application being executed on the UE. Further, the TDD frame format used by two base stations may be different, and here again the TDD frame format used by each base station may be at least partially dependent on the application types of UEs in the respective cells of the base stations.

One problem with TDD is that transmission and reception are performed at the same frequency. If two neighboring base stations are operating where one is performing transmission and one is performing reception, a mechanism is desired to help the base stations avoid interference. A dynamic TDD solution may be utilized to improve transmission quality and accommodate higher frequencies. It is noted that an FDD solution may also be used for certain areas or markets.

In some embodiments, cross layer communication may be introduced, such as the provision of TCP/UDP and application type as part of the transmission of TTI/resource size information. In some embodiments, the base station (eNB) operates to configure device to device (D2D) resources dynamically when two or more UEs are in range, enabling the two or more UEs to communicate directly with each other to reduce delay. In other words, the base station may dynamically configure the frame types used for direct communication between two or more UEs, such that the base station may configure a first frame type for use between two or more UEs at a first instance of time, at least partially dependent on the application type or type of communication being exchanged between the two or more UEs at the first instance of time, and the base station may configure a second frame type for use between the two or more UEs at a second instance of time, at least partially dependent on the application type or type of communication being exchanged between the two or more UEs at that second instance of time. Further, to avoid complexity when performing carrier aggregation, carriers may range from 10 to 200 MHz. Finally, it may be desired to use the same TTI frame both in licensed and unlicensed spectrum. In other embodiments, different TTI frame formats may be used in licensed and unlicensed spectrum.

Thus, some embodiments of a cellular communication system utilize a dynamic frame structure, wherein the frame structure can be adapted to fit different application requirements and TTI durations. This frame structure may be used in transmission protocols similar to the current LTE standard, using downlink and uplink channels as well as a control channel and a shared data channel. In these systems, the base station may send control data to the UE, and the UE may use this received control data to aid in decoding the received data.

In one embodiment, the proposed frame structure has a 10 ms “base” duration to define radio resource management (RRM) measurements for the RAT. A version of this new frame structure may be defined for use in time division duplexing (TDD) mode (for either uplink or downlink), and the same or a different version may be defined for use in frequency division duplexing (FDD) mode. New (5G) RATs may support both downlink and uplink shared channels, and may also support a control channel. The same control channel could be used for both downlink and uplink allocation, but the location of the control channel may be dynamic, i.e., the location of the control information in the frame may not be fixed.

Also, the timing between data transmission and the HARQ ACK/NACK may not be fixed. In current systems, the ACK/NACK is sent 4 ms after the transmitted data has been received from the base station. In some embodiments, this static timing is not used in the cellular standard. Instead, the proposed cellular system may utilize dynamic timing between the HARQs, the ACK/NACK, and the data transmission

In addition, the reference pilot signals may be sent only in the beginning of a 10 ms or 1 ms frame and may be inserted into the control channel at each TTI allocation.

### Dynamic TDD Frame Format Operation

After the RACH and attach procedure whereby a UE connects to the network, the network may assign to each UE a time/bandwidth location for the UE to monitor for the first control data allocation, e.g., the first instance of the PDCCH where the UE's control information may be present. The network may also provide in this control information a duration between control channel occasions, which may be the TTI. The control message sent to the UE (e.g., in the PDCCH) may operate to override the UE's prior information regarding location/time of the next control occasion (the next PDCCH location) in addition to the next TTI control occasion. The control channel may carry information about both uplink and downlink TTI (the same TTI could be used for both uplink or downlink). The control channel information may be persistent or constant over multiple TTIs in order to reduce control overhead for very short TTI durations.

The control channel may provide the following information: the downlink resource block/time assignments; the TTI size, next control occasion (next PDCCH), MIMO information, HARQ process and HARQ ACK/NACK resources (when the UE should send the ACK/NACK of the HARQ), and bandwidth/timing location; the uplink resource block/time assignments; and the TTI size, next control occasion (next PDCCH), and MIMO information for the uplink.

In Dynamic TDD, the network may define a coordination mechanism between neighboring base stations (eNBs) in order to ensure that each base station is aware of the UL/DL allocation and transmission power of each device/base station at a specific time. In other words, a first base station may communicate with a second neighboring base station regarding the current frame structure being used, whether uplink or downlink transmission is currently being performed (or to be performed), and the transmission power being used (or to be used). This may help to avoid interference issues.

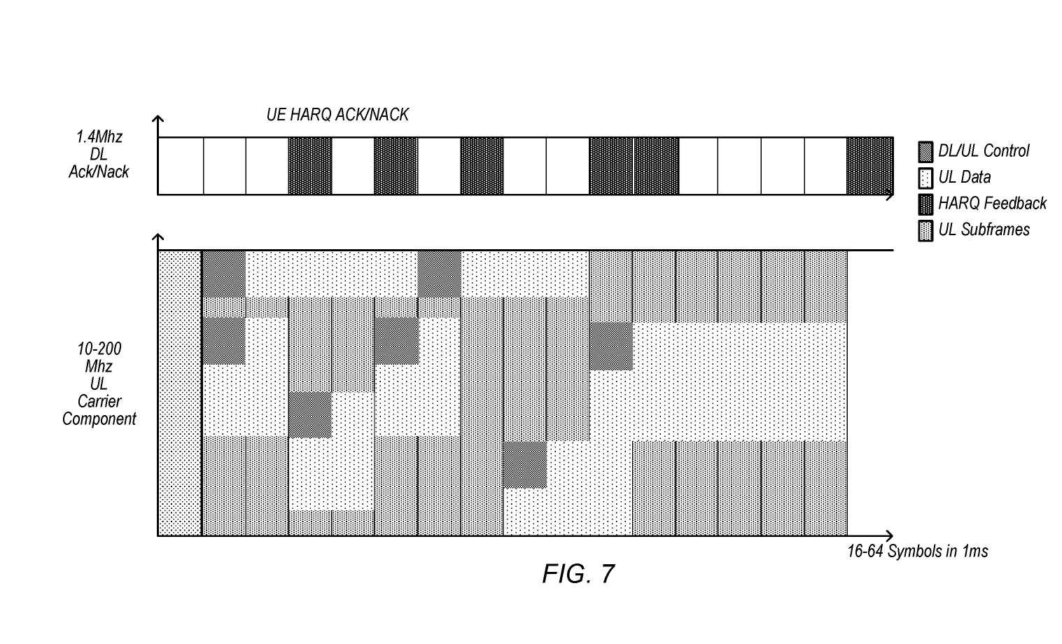

### FIGS. 6 and 7—Dynamic Frame Structure First Embodiment

FIGS. 6 and 7 illustrate a dynamic frame structure according to some embodiments, specifically a dynamic TDD self-contained frame. FIG. 6 illustrates an example of downlink subframes, and FIG. 7 illustrates an example of uplink subframes.

As shown in FIG. 6, the frames used in communication in this embodiment may comprise a 10-200 MHz downlink frame carrier component (bottom of FIG. 6) and a separate lower bandwidth channel (top of FIG. 6) used for uplink (UL) ACK/NACK. The first portion of the 10-200 MHz downlink frame carrier component may comprise a DL signal for radio resource management, e.g., pilot symbols (shown as “RRM DL Signals”). This may be followed by control signaling (shown as “DL/UL Control”) which may then be followed by downlink data (labeled as “DL Data”). The arrows shown in FIG. 6 indicate the relationship between the transmitted downlink data and the corresponding HARQ feedback (Ack/Nacks) that indicate the UE's acknowledgement or negative acknowledgement of receipt of the transmitted data.

As shown, the subframes used for communication between the base station and the UE can have different TTI durations. For example, the base station can specify different TTI durations to a UE (or multiple UEs) based on the type of application currently being run on the UE. The base station communicating with the UE may be configured to indicate different TTI durations to the UE at different times, depending on the application type current executing on the UE. Thus the UE may be configured to receive, from a base station in the cellular network, first control information on a control channel specifying a first transmit time interval between control channel transmissions, and at a later time, receive, from the base station, second control information specifying a second different transmit time interval between control channel transmissions.

A first transmit time interval may be specified for a first type of application executing on the UE, and a second transmit time interval may be specified for a second type of application executing on the UE. The first type of application may execute more efficiently with the first transmit time interval duration, and the second type of application may execute more efficiently with the second transmit time interval duration. The base station may also specify different transmit time intervals for uplink and for downlink. Further, the location of the control channel may not be fixed, but rather may be dynamically determined and indicated by the based station.

In this example embodiment, the HARQ ACK/NACK is not multiplexed with the data. As shown, a 10-200 MHz frame carrier component may be used by the base station for downlink (FIG. 6) or uplink (FIG. 7), and the base station may switch at any point in time from downlink to uplink or vice versa. The ACK/NACK may be transmitted by the UE over a reduced bandwidth frequency, e.g., from 1.5 to 5 MHz, which is a reduced bandwidth relative to the bandwidth available to the UE, or relative to the DL Frame Carrier Component at the bottom of FIG. 6. FIG. 6 shows the UL control carrier labeled “X MHz UL ACK/NACK” transmitted by the UE (top of FIG. 6), with the HARQ feedback (ACK/NACKs) shown as shaded in the carrier. As shown, these ACK/NACKs are transmitted using a reduced amount of bandwidth relative to the possible amount of bandwidth that could be used, and are transmitted in a separate channel.

As shown, after a pilot symbol (RRM DL signals) has been received, the UE next reads the control channel (DL/UL Control) which indicates where the data is located (where in the PDSCH to read the data) as well as the size of the data. For example, the control channel (PDCCH) may indicate that the data comprises 4 OFDM symbols. The control channel may also indicate the next location of the PDCCH which contains control information for the respective UE. In a subsequent control channel, the control information may indicate a lesser number of OFDM symbols, e.g., three OFDM symbols, where the TTI has been shortened. The control channel thus provides the duration of each transmission, and the length of transmission (the TTI) indicated by the control channel may be dynamic. Thus certain types of services, such as MTC or IoT devices, which need only a very short TTI, could use a first frame structure configuration having a short TTI where data is split among 4 OFDM symbols. For other types of services which require a larger TTI, the control channel may indicate a second frame structure configuration having a larger TTI. This second configuration and larger TTI may be used for UEs that need higher bandwidth and/or shorter end-to-end delay. Here again the ACK/NACK is returned by the UE immediately after it reads the PDSCH (the data).

The operation shown in FIG. 6 may be extrapolated to multiple UEs. Thus, the base station may schedule multiple UEs, each with different TTI/resource block allocations during downlink TTIs.

FIG. 7 illustrates a similar example, but showing an uplink subframe transmitted by the base station to the UE followed by ACK/NACKs received on the downlink from the UE. As shown, after transmission of pilot symbols, control information may be sent in the uplink from the UE to the base station. Following the control information, uplink data may be sent as indicated by “UL Data”, and other UL subframes may also be transmitted. The HARQ feedback (ACK/NACKs) are transmitted by the base station in the DL on a separate channel (top of Figure) as shown, preferably a 1.4 MHz channel.

As discussed with respect to FIG. 7, the base station can specify different TTI durations to a UE (or multiple UEs) based on the type of application currently being run on the UE. The base station communicating with the UE may be configured to indicate different TTI durations to the UE at different times, depending on the application type current executing on the UE. Thus as shown in FIG. 7 different TTI interval durations can be used at different time during communication between the UE and the base station.

The solution proposed in FIGS. 6 and 7 uses a secondary channel for the ACK/NACK. In other words, the solution shown in FIGS. 6 and 7 does not multiplex or intersperse the HARQ feedback (ACK/NACKs) among the data, but rather uses a separate channel for the downlink and uplink HARQ feedback.

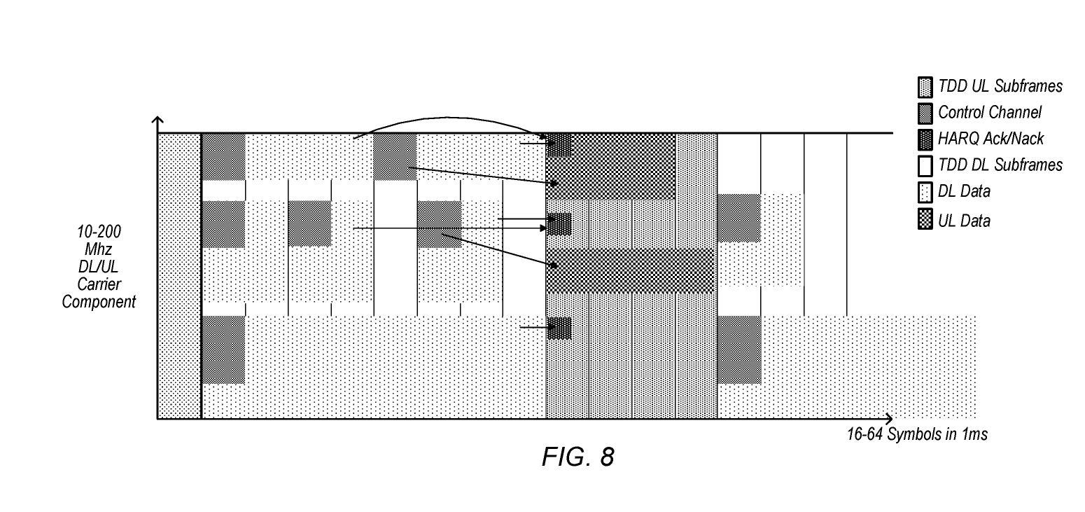

### FIG. 8—Dynamic Frame Structure Second Embodiment

FIG. 8 shows an alternate embodiment of a dynamic frame structure where the HARQ feedback (ACK/NACKs) are transmitted in the same channel, i.e., are not transmitted in a separate channel. As shown, since the uplink and downlink transmissions are TDD (time division duplexed), the ACK/NACKs may not be sent right after the appropriate data is transmitted, but rather transmission of the ACK/NACKs may be delayed until TDD transmission direction switches. For example, the UE may receive first data in the downlink (PDSCH), followed by control information in the control channel (PDCCH) and followed by further second data, and when the TDD transmission switches to uplink, at that time the UE is able to transmit its HARQ feedback in the uplink for the first data and for the second data. One benefit of this embodiment is that the UE/base station is not required to locate the separate 1.4 MHz secondary channel to find and read the HARQ feedback. One drawback to this embodiment is that the UE/base station may not be able to transmit its HARQ feedback (ACK/NACKs) immediately after data is received, which increases the end-to-end delay of the transmission.

The embodiment shown in FIG. 8 is similar in many respects to that shown in FIGS. 6 and 7, e.g., the TTI duration and the location of control information may be dynamic, i.e., may change over time. For example, the TTI duration may be dynamically changed by the base station at least in part in response to the application type currently executing on the UE.

In another embodiment, the cellular system may utilize a dynamic TDD self-contained frame per channel. This frame structure design is similar to previous ones described above. However, one difference is that this frame structure does not mix different TTI sizes/bandwidth allocations in the same carrier. Instead, a portion of the overall frequency bandwidth (e.g., the lower bandwidth) is used for cellular operations similar to that shown in FIGS. 7-9 above using HARQ feedback, etc., and the upper portion of the frequency may be used for newer services such as MTC, etc. Thus one significant feature of this frame structure is that carriers (or portions of the frequency bandwidth) may be reserved for certain applications/quality of services (1.4 MHz to 80 Mhz). The TTI may be similar for all users within this carrier. The base station (eNB) may use a TDD frame type per carrier.

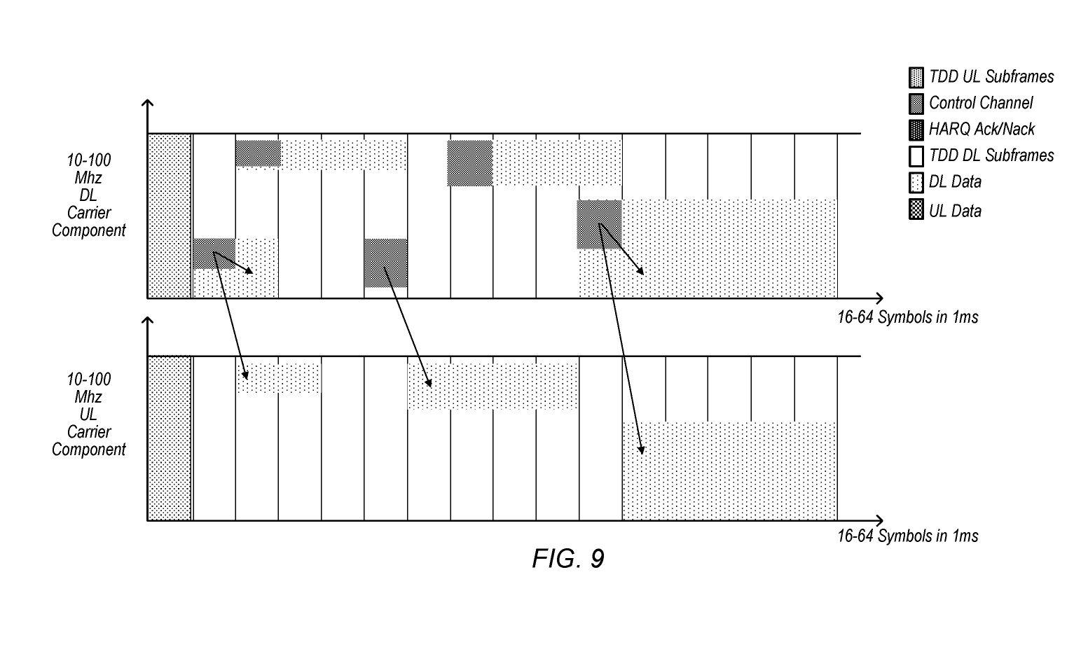

### FIG. 9—FDD Frame Structure

FIG. 9 illustrates a frame structure for frequency division duplexing (FDD) according to some embodiments, specifically a FDD self-contained frame with downlink/uplink scheduling. In FDD communications, different frequencies are defined for use in the downlink and the uplink. As shown, one 10-100 MHz carrier component may be used for downlink, and one 10-100 MHz carrier component may be used for uplink. In the example shown in FIG. 9, after the pilot symbol is transmitted in the initial 10 ms frame, control information (indicated by gray shading) in the control channel (PDCCH) sent in the downlink carrier may indicate both where data resides in the downlink and also where the UE is allowed transmit HARQ feedback (ACK/NACK) in the uplink.

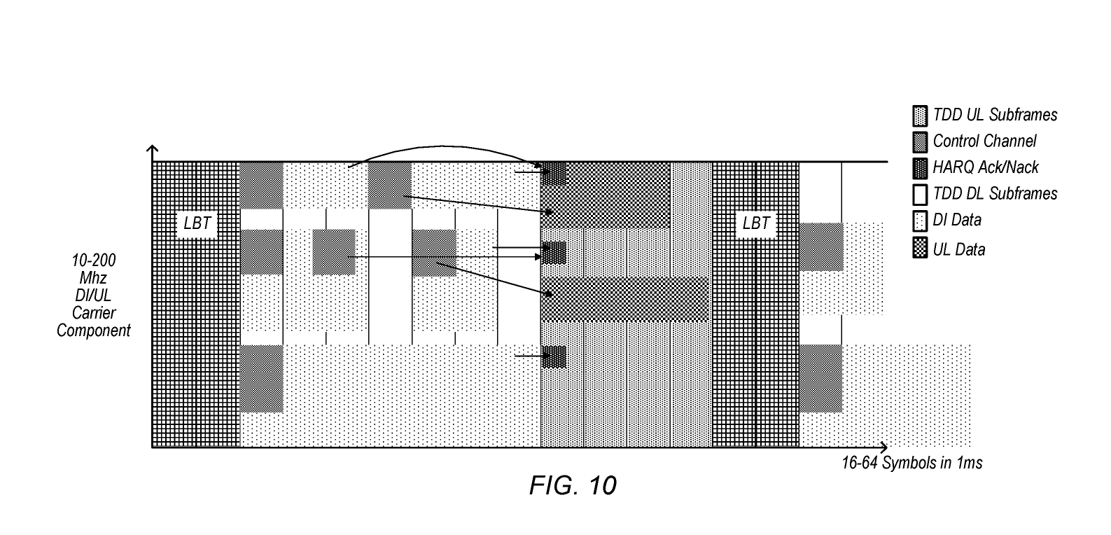

### FIG. 10—LAA Frame Structure

FIG. 10 illustrates a frame structure for use in cellular networks that may also utilize the unlicensed 5 GHz band currently used by Wi-Fi devices. This may also be referred to as license assisted access (LAA) frame structure, according to some embodiments. This LAA frame structure is similar to the frame structure of the second embodiment shown in FIG. 8 above, where the control information in the control channel from the base station indicates both the location of the data (in the PDSCH) and the location in the uplink where HARQ feedback can be transmitted. As shown, this frame structure may incorporate a contention protocol known as listen-before-talk (LBT).

Some embodiments may be realized in any of the following forms:

In some embodiments, a wireless user equipment (UE) may comprise a radio comprising one or more antennas configured for wireless communication on a cellular network, and a processing element operably coupled to the radio.

The UE may be configured to receive, from a base station in the cellular network, first control information on a control channel specifying a first location of subsequent first control information in the control channel.

The UE may be further configured to, at a later time, receive from the base station second control information specifying a second different location of subsequent second control information in the control channel.

In some embodiments, a UE may be configured wherein a first transmit time interval is specified for a first type of application executing on the UE; and wherein a second transmit time interval is specified for a second type of application executing on the UE.

In some embodiments, the first type of application may execute more efficiently with the first transmit time interval, and the second type of application may execute more efficiently with the second transmit time interval.

In some embodiments, a base station (BS) may comprise a radio comprising one or more antennas configured for wireless communication and a processing element operably coupled to the radio.

The BS may be configured to transmit first control information to a first UE, wherein the first control information specifies a first transmit time interval between control channel transmissions.

The BS may be further configured to transmit second control information to a second UE, wherein the second control information specifies a second transmit time interval between control channel transmissions. A length of each of the first transmit time interval and the second transmit time interval may depend on a type of service executing on the first and second UEs, wherein the type of service may comprise one of machine type communications (MTC), enhanced mobile broadband (eMBB), and critical machine applications.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless user equipment (UE), comprising:
a radio, comprising one or more antennas configured for wireless communication on a cellular network;
a processing element operably coupled to the radio;
wherein the UE is configured to:
receive, from a base station in the cellular network, first control information on a control channel dynamically specifying a first transmit time interval between control channel transmissions;
wherein a duration of the first transmit time interval is determined based at least in part on a type of service executing on the UE, wherein the type of service may comprise one of machine type communications (MTC), enhanced mobile broadband (eMBB), and critical machine applications.

2. The UE of claim 1,
wherein the first control information specifies different transmit time intervals for uplink and for downlink.

3. The UE of claim 1,
wherein the UE is further configured to:
receive, from the base station, first control information on a control channel specifying a location of subsequent control information in the control channel;
wherein the location of the subsequent control information in the control channel is dynamically determined by the base station.

4. The UE of claim 1,
wherein the first control information dynamically specifies a timing between data transmission and automatic repeat request feedback.

5. The UE of claim 4,
wherein the first control information specifies a first timing between data transmission and automatic repeat request feedback; and
wherein at a later time the UE is configured to receive second control information which specifies a second different timing between data transmission and automatic repeat request feedback.

6. The UE of claim 1,
wherein the first control information dynamically specifies a first location for transmission of automatic repeat request feedback.

7. The UE of claim 6,
wherein the first control information specifies a first location for transmission of automatic repeat request feedback; and
wherein at a later time the UE is configured to receive second control information which specifies a second different location for transmission of automatic repeat request feedback.

8. The UE of claim 6,
wherein the first location of the automatic repeat request feedback specifies a separate channel from the control channel, wherein the separate channel has a lower bandwidth than the control channel.

9. The UE of claim 1,
wherein the UE is configured to receive a frame comprising data resource elements arranged in a contiguous fashion.

10. The UE of claim 1,
wherein the UE is configured to receive a frame comprising a pilot signal and a plurality of data resource elements, wherein the pilot symbol is not multiplexed within the data resource elements.

11. A wireless user equipment (UE) device, comprising:
a radio, comprising one or more antennas configured for wireless communication on a cellular network;
a processing element operably coupled to the radio;
wherein the UE is configured to:
receive, from a base station in the cellular network, first control information on a control channel specifying a first transmit time interval between control channel transmissions, wherein a duration of the first transmit time interval is determined based at least in part on a type of service executing on the UE, wherein the type of service may comprise one of machine type communications (MTC), enhanced mobile broadband (eMBB), and critical machine applications;
at a later time, receive, from the base station, second control information specifying a second different transmit time interval between control channel transmissions, wherein a duration of the first transmit time interval is determined based at least in part on a type of service executing on the UE, wherein the type of service may comprise one of machine type communications (MTC), enhanced mobile broadband (eMBB), and critical machine applications.

12. A base station (BS), comprising:
a radio, comprising one or more antennas configured for wireless communication;
a processing element operably coupled to the radio;
wherein the base station is configured to:
transmit, to a user equipment (UE), first control information on a control channel dynamically specifying a first transmit time interval between control channel transmissions;
wherein a duration of the first transmit time interval is determined based at least in part on a type of service executing on the UE, wherein the type of service may comprise one of machine type communications (MTC), enhanced mobile broadband (eMBB), and critical machine application.

13. The base station of claim 12,
wherein the base station is configured to dynamically adjust a frame structure of transmissions being used with the first UE based on the current type of service being executed on the UE.

14. The base station of claim 12,
wherein the base station is configured to:
dynamically determine a location in a control channel for control information to be placed in the control channel for transmission to the UE;
transmit the dynamically determined location to the UE in the control channel; and
transmit the control information to the UE in the control channel at the dynamically determined location.

15. The base station of claim 12,
wherein the first control information dynamically specifies a timing between data transmission and automatic repeat request feedback.

16. The base station of claim 12,
wherein the first control information dynamically specifies a first location for transmission of automatic repeat request feedback.

17. The base station of claim 16,
wherein the first location of the automatic repeat request feedback specifies a separate channel from the control channel, wherein the separate channel has a lower bandwidth than the control channel.

18. The base station of claim 12,
wherein the base station is configured to transmit, to the UE, a frame comprising data resource elements arranged in a contiguous fashion.

19. The base station of claim 12,
wherein the base station is configured to transmit, to the UE, a frame comprising a pilot signal and a plurality of data resource elements, wherein the pilot symbol is not multiplexed within the data resource elements.

20. The base station of claim 12,
wherein the base station is configured to provide information to a neighboring base station specifying current uplink/downlink allocation and transmission power of the base station in order to reduce interference issues with the neighboring base station.
